(19) United States
(12) Patent Application Publication
(10) Pub. No.: US 2008/0235274 A1
(43) Pub. Date: Sep. 25, 2008

(54) Program Table Creation Method, Program Table Creation Device, and Program Table Creation System

(75) Inventors: Hirotoshi Iwasaki, Tokyo (JP); Nobuhiro Mizuno, Tokyo (JP); Shinichiro Sega, Tokyo (JP); Fumio Mizoguchi, Tokyo (JP); Hironori Hiraishi, Tokyo (JP)

Correspondence Address: LOUIS WOO;LAW OFFICE OF LOUIS WOO, 717 NORTH FAYETTE STREET, ALEXANDRIA, VA, 22314, US

(73) Assignee: DENSO IT LABORATORY, INC., Shibuya-ku, Tokyo (JP)

(21) Appl. No.: 10/593,721

(22) PCT Filed: Mar. 31, 2005
(86) PCT No.: PCT/JP05/06368

§ 371 Date: Apr. 13, 2007

(30) Foreign Application Priority Data
Mar. 31, 2004 (JP) 2004-102506

(51) Int. Cl. G06F 17/30

(52) U.S. Cl. 707/104.1; 707/E17.001

(57) ABSTRACT

There is disclosed a technique for automatically creating a detailed program table for playing contents according to various conditions. According to this technique, a constraint condition generation unit 103 acquires a condition (constraint condition) related to a user and describes this constraint condition through the use of a constraint condition description function. A constraint condition solution unit 104 carries out constraint solution processing by making reference to content attribute information stored in a content attribute storage unit 124 on the basis of the constraint condition description function supplied from the constraint condition generation unit, thereby deriving an optimal program table (optimal solution) defining a temporal arrangement of a plurality of contents. Moreover, in the case of constraint excess which leads to finding no optimal solution, a constraint condition priority acquisition unit 105 narrows down an optimal program table or performs recalculation while, in the case of constraint shortage which leads to finding a plurality of optimal solutions, a score setting unit 106 narrows down an optimal program table or performs recalculation. On the basis of the optimal program table thus created, a content acquisition unit 109 carries out content acquisition processing and a program playing unit 110 performs playing processing.

### TECHNICAL FIELD

The present invention relates to a program table creation method, program table creation device, and program table creation system for creation of a program table to be used for playing of contents.

### BACKGROUND ART

So far, portable mobile communication terminals such as portable telephones, PHS (Personal Handyphone System) terminals and PDAs (Personal Digital Assistance), communication apparatus mounted in mobile bodies such as vehicle, ship and aircraft, or other devices, have been capable of receiving and playing contents such as musical piece data and video data through radio communications. For example, there have been known a method of viewing and listening to television programs and radio programs by receiving and playing broadcast electric waves for televisions and radio receivers, a method of viewing and listening to programs delivered through networks by receiving and playing digital contents such as video data and musical piece data from a predetermined server through a digital communication network or the like, and other manners.

However, the delivery of contents according to the above-mentioned broadcast mode leads to providing the same program (contents) to an unspecified number of users, which creates a problem in that a user cannot always enjoy the contents he/she wants to view and listen to. For coping with such a problem, there have been known many content delivery systems capable of carrying out the content delivery according to the on-demand format in consideration of user's likes.

In addition, the following Patent Document 1 discloses a music/information providing apparatus used in the interior of a vehicle and capable of making a program composition on the basis of set information (profile), set by a user, with respect to contents such as the contents delivered through broadcast communications, the internet or the like and contents stored in locally existing recording media (CD (Compact Disc), DVD (Digital Versatile Disk) and others). Incidentally, the technique disclosed in this Patent Document 1 enables a user to previously customize the set information for the program composition, desired program composition/information contents and others through the use of a personal computer or the like so as to reduce the number of times of operations of devices while driving a vehicle, thereby achieving the enhancement of safety during the running of a vehicle.

Patent Document 1: Japanese Patent Application Publication No. 2001-343979 (FIGS. 1, 3, 5 and 7)

However, although the technique disclosed in the Patent Document 1 can reduce the number of times of operations in the interior of a vehicle, the program composition depends greatly upon operations the user conducts in advance, and the user should fulfill a role in the program composition. For this reason, the technique disclosed in the Patent Document 1 cannot automatically create a program table for the playing of the contents on the basis of time and sequence according to various conditions such as user's likes and situations.

That is, the technique disclosed in the Patent Document 1 creates the following problems.
There is no method (algorithm) of composing a program automatically and, in consideration of the setting a user conducts in advance, the total number of times of operations is not always reducible.
It is possible that the sequencing of corners and contents a user likes is made on the basis of a user's history and the playing is made according to this sequence. However, for example, in the case of the creation of a two-hour program, when the playing starts at the corners and contents the user likes, the corners and contents the user dislike are played at the latter half of the program. Accordingly, it is unexpected that the user's satisfaction level becomes higher with respect to the entire program.
Even if the skip rate (index indicative of the degree of utilization of contents: see FIG. 5(b) of the Patent Document 1) with respect to the corners and the contents is indicated on the basis of the user's history, the skip rate is only reference data to be used when a user composes a program and the determination of a corner length, playing time and sequence and others on the basis of this reference data depends upon the user's work. Therefore, the reference data such as the skip rate cannot be used efficiently and, hence, the creation of an optimized program is impossible unless operated by a user.
It is impossible that the optimization of the entire program is made so as to pursue the user's palatability as the entire program.
Difficulty is experienced in coping with a state in which a large number of contents appear as candidates for a plurality of programs, which can occur under a situation where various conditions such as user's likes, situation and playing time of entire program are intertwined complicatedly, or a state in which the contents forming the candidate for a program disappear, which makes it impossible to create a detailed program table, considering various conditions, on a case-by-case basis.

### DISCLOSURE OF THE INVENTION

The present invention has been developed in consideration of the above-mentioned problems, and it is an object of the invention to provide a program table creation method, program table creation device and program table creation system, capable of automatically creating a detailed program table for the playing of contents.

For achieving this purpose, in accordance with the present invention, there is provided a program table creation method of creating a program table defining a temporal arrangement of a plurality of contents, characterized in that the program table is created through the use of a constraint solution technique on the basis of a constraint condition related to a selection of the plurality of contents and/or a constraint condition related to the temporal arrangement of the plurality of contents.

In addition, according to the present invention, as the above-mentioned program table creation method, there is provided a program table creation method characterized in that a description of the constraint condition is made through the use of a constraint condition description function defined in advance.

Still additionally, according to the present invention, as the above-mentioned program table creation method, there is provided a program table creation method characterized in that user's liking information indicative of a liking of a user who watches or hears the contents is acquired as the constraint condition.

Yet additionally, according to the present invention, as the above-mentioned program table creation method, there is provided a program table creation method characterized in that the constraint condition is automatically acquired by automatically generating the user's liking information through learning of the user's liking.

Moreover, according to the present invention, as the above-mentioned program table creation method, there is provided a program table creation method characterized in that state information indicative of a state related to playing of the contents is acquired as the constraint condition.

Still moreover, according to the present invention, as the above-mentioned program table creation method, there is provided a program table creation method characterized in that the program table is created by making reference to content attribute information indicative of an attribute of each of the plurality of contents.

Yet moreover, according to the present invention, as the above-mentioned program table creation method, there is provided a program table creation method characterized in that, when constraint falls into an excess state in constraint solution processing at the creation of the program table, priorities are set with respect to the contents and/or the constraint condition so that the constraint solution processing is conducted while preferentially employing the constraint condition higher in priority.

Furthermore, according to the present invention, as the above-mentioned program table creation method, there is provided a program table creation method characterized in that, when constraint falls into a shortage state in constraint solution processing at the creation of the program table, scores are set with respect to the contents and/or the constraint condition so that the constraint solution processing is conducted by making a comparison between operation results of operations using a function in which the score is set as a parameter.

Still furthermore, according to the present invention, as the above-mentioned program table creation method, there is provided a program table creation method characterized in that a constraint logical programming technique is used as the constraint solution technique.

Yet furthermore, according to the present invention, as the above-mentioned program table creation method, there is provided a program table creation method characterized in that the program table is expressed by a tree structure having one or a plurality of hierarchies in which elements indicative of the contents constituting the program table are disposed in a lowest-rank layer and elements summarizing features of lower-rank elements are disposed in a rank higher with respect to the elements indicative of the contents, and the elements associated with each other in higher-rank and lower-rank layers have information consistent with each other.

In addition, according to the present invention, as the above-mentioned program table creation method, there is provided a program table creation method characterized in that the elements associated with each other in the higher-rank and lower-rank layers have attribute information or time width information consistent with each other.

Still additionally, according to the present invention, as the above-mentioned program table creation method, there is provided a program table creation method characterized in that a portion of the program table is rearranged on the basis of the tree structure.

Yet additionally, according to the present invention, as the above-mentioned program table creation method, there is provided a program table creation method characterized in that the rearrangement of the portion of the program table is made by employing one of a method of deriving a new solution through the use of a previous solution or a method of deriving a new solution through the use of a history related to a previous solution derivation, or by employing a combination of these methods.

Moreover, in accordance with the present invention, there is provided a program table creation method in which the arrangement of the contents is optimized on the basis of one of a score set in the contents, a correlation of attributes of the contents and a correlation of the contents or a combination thereof at the creation of the program table or after the creation thereof.

Still moreover, in accordance with the present invention, there is provided a program table creation method in which the content to be disposed at the next position is determined on the basis of the contents disposed at the last position with respect to a time axis.

Yet moreover, in accordance with the present invention, there is provided a program table creation method in which the content to be disposed at the last position is determined on the basis of the content to be disposed at the next position with respect to a time axis.

Furthermore, in accordance with the present invention, there is provided a program table creation method in which an arrangement of the contents is determined on the basis of a pattern of the plurality of contents with respect to a time axis.

Still furthermore, in accordance with the present invention, there is provided a program table creation method in which the arrangement of the contents is changed by making reference to the content attribute information indicative of attributes of the contents so that the correlation between the contents adjacent to each other reaches a maximum as a whole.

In addition, for achieving the above-mentioned purpose, in accordance with the present invention, there is provided a program table creation device for creating a program table defining a temporal arrangement of a plurality of contents, characterized in that the program table is created through the use of a constraint solution technique on the basis of a constraint condition related to a selection of the plurality of contents and/or a constraint condition related to the temporal arrangement of the plurality of contents.

Still additionally, according to the present invention, as the above-mentioned program table creation device, there is provided a program table creation device characterized in that the program table creation device is mounted in a vehicle and made to create the program table of programs to be watched and heard in the interior of the vehicle.

Yet additionally, according to the present invention, as the above-mentioned program table creation device, there is provided a program table creation device characterized in that a constraint logical programming technique is used as the constraint solution technique.

Furthermore, for achieving the above-mentioned purpose, in accordance with the present invention, there is provided a program table creation system for creating a program table defining a temporal arrangement of a plurality of contents, characterized by comprising

a program table creation server existing in the predetermined network and so arranged that the program table is created through the use of a constraint solution technique on the basis of a constraint condition related to a selection of the plurality of contents and/or a constraint condition related to a temporal arrangement of the plurality of contents, and

a communication unit connectable with the predetermined network and capable of transmitting the constraint condition through the predetermined network to the program table creation server and receiving the program table created by the program table creation server.

Still furthermore, according to the present invention, as the above-mentioned program table creation system, there is provided a program table creation system characterized in that the communication unit is mounted in a vehicle and the program table creation server creates the program table of programs to be watched and heard in the interior of the vehicle.

Still furthermore, according to the present invention, as the above-mentioned program table creation system, there is provided a program table creation system characterized in that a constraint logical programming technique is used as the constraint solution technique.

The present invention has the above-mentioned configurations and can automatically create a detailed program table for the playing of contents according to various conditions.

In addition, according to the present invention, a program can be automatically created as a satisfaction solution (optimal solution) of a constraint condition derived through the use of a constraint solution technique and, particularly, the user's liking relative to a program and other conditions can be converted into declaratory constraint conditions in the constraint logical programming technique so as to create programs automatically as the satisfaction solutions (optimal solutions) of these constraint conditions.

Still additionally, according to the present invention, the information such as a length of each corner suiting a user's liking, a playing time of each corner or each content and playing sequence or periodicity among the corners or contents can be acquired as constraint conditions on the basis of the user's history so as to automatically create programs satisfying these constraint conditions. Yet additionally, it is also possible to acquire the constraint conditions on the basis of, combined with the user's history, the liking of users having a profile data similar to that of the user or common users, and further to make a combination with the constraint conditions based upon the user's history.

Moreover, according to the present invention, it is possible to automatically create programs satisfying, in addition to the above-mentioned constraint conditions related to the user's liking, semi-compulsory constraint conditions occurring due to contents provider, service provider, program offering company, broadcasting station, network, contract, other person and other vehicle.

Still moreover, according to the present invention, it is possible to create a program with a high palatability at that time by combining constraint conditions inputted by an operation by a user through a user interface with the above-mentioned constraint conditions (constraint conditions related to user's liking or semi-compulsory constraint conditions) which does not rely on a manual operation by a user. The constraint conditions to be inputted at this time can also set not only the lengths or sequence of corners but also the contents to be concretely played and the broadcast time thereof.

Yet moreover, according to the present invention, it is possible to dynamically change the above-mentioned constraint conditions (constraint conditions related to the user's liking, semi-compulsory constraint conditions and constraint conditions inputted through an operation by a user) according to various situation variations even in process of a program and to achieve the re-composition of a program with a variation of constraint conditions as a trigger.

In addition, according to the present invention, the entire program can be optimized through the use of an objective function expressing a user's palatability, thereby pursuing the user's palatability on the program as a whole.

Still additionally, according to the present invention, the entire program can be optimized through the use of an objective function expressing a user's palatability, thereby recommending a plurality of programs ranked according to the value of the objective function to a user so that the user can select a program most suitable for the user's liking at that time from the recommended programs.

Yet additionally, according to the present invention, when the number of constraint conditions extremely increases, a priority is set with respect to each of the constraint conditions on the basis of the user's history constraint condition and a liking of a user having profile data similar to that of the user or common user, which enables a program to be created while preferentially employing a constraint condition higher in priority.

Moreover, according to the present invention, a program table can be expressed by a hierarchical tree structure so as to place the conditions related to the components (elements) of the tree structure under restraint, thereby restraining the conditions on the elements in the higher-rank and lower-rank hierarchies associated with the elements, which improves the efficiency of the restraint solution processing.

Still moreover, according to the present invention, a portion (for example, remaining program contents after the playing up to a partway) of a program can be rearranged on the basis of the tree structure through the use of an initial value utilizing method an/or a constraint recording method, thereby speeding up the rearrangement of the program.

Yet moreover, according to the present invention, at the creation of a program table or after the creation thereof, the arrangement of contents is changed in consideration of a flow of the entire program within a range satisfying the constraint condition, thereby enabling a creation of a program table closer to the user's needs.

### BRIEF DESCRIPTION OF THE DRAWINGS

FIG. 1 is a block diagram showing one example of a configuration of a program table creation device according to an embodiment of the present invention;

FIG. 2 is a flow chart showing one example of a program table creation method according to an embodiment of the present invention;

FIG. 3 is an illustration of one example of content attribute information set with respect to each content to be used in an embodiment of the present invention;

FIG. 4 is an illustrative view showing one example of a constraint condition to which reference is made at a creation of a program table according to an embodiment of the present invention and one example of an optimal solution derived on the basis of this constraint condition;

FIG. 5 is an illustrative view showing a hierarchical relationship among a program, a corner and contents in an embodiment of the present invention;

FIG. 6 is an illustrative view showing one example of a program table to be created finally by a program table creation device according to an embodiment of the present invention;

FIG. 7A is an illustration of a first example of arrangement optimization of contents in a corner according to an embodiment of the present invention;

FIG. 7B is an illustration of a second example of arrangement optimization of contents in a corner according to an embodiment of the present invention;

FIG. 7C is an illustration of a third example of arrangement optimization of contents in a corner according to an embodiment of the present invention;

FIG. 7D is an illustration of a fourth example of arrangement optimization of contents in a corner according to an embodiment of the present invention;

FIG. 8 is an illustrative view showing a concept of a tree structure to be used in constraint solution processing according to an embodiment of the present invention;

FIG. 9 is a flow chart showing one example of an algorithm of constraint solution processing using a tree structure according to an embodiment of the present invention; and

FIG. 10 is an illustration of one example of starting timing of re-scheduling of a program table according to an embodiment of the present invention.

### BEST MODE FOR CARRYING OUT THE INVENTION

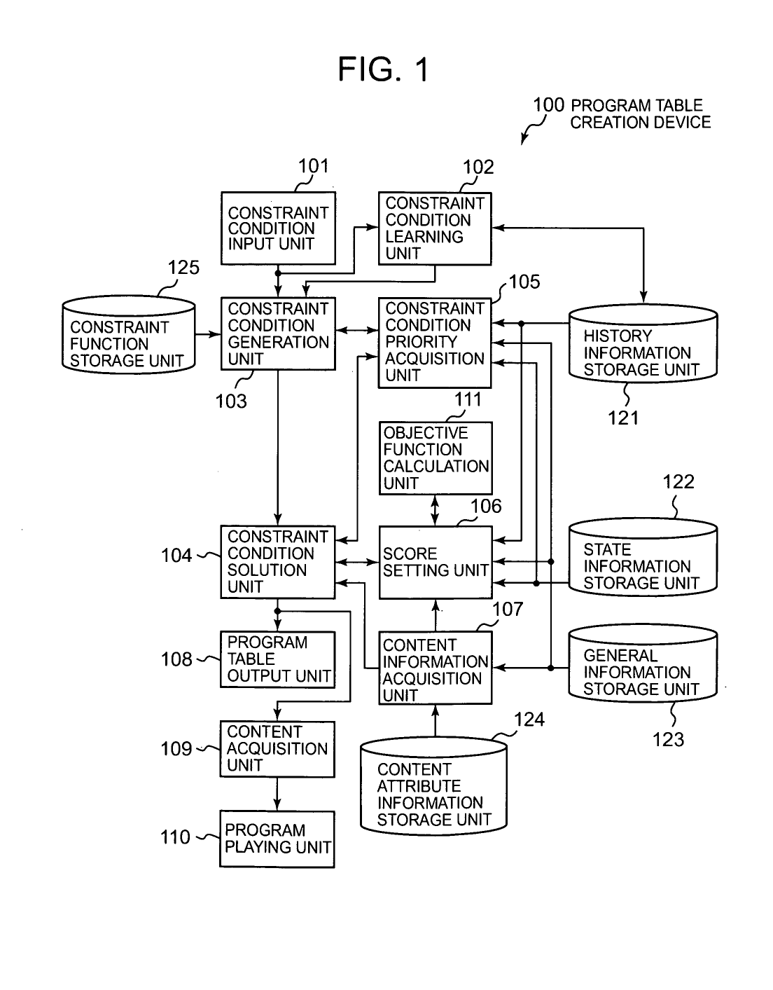

Embodiments of the present invention will be described hereinbelow with reference to the drawings. First of all, referring to FIG. 1, a description will be given of a program table creation device according to an embodiment of the present invention. FIG. 1 is a block diagram showing one example of a configuration of a program table creation device according to an embodiment of the present invention. The program table creation device 100 shown in FIG. 1 is made up of a constraint condition input unit 101, a constraint condition learning unit 102, a constraint condition generation unit 103, a constraint condition solution unit 104, a constraint condition priority acquisition unit 105, a score setting unit 106, a content information acquisition unit 107, a program table output unit 108, a content acquisition unit 109, a program playing unit 110, a history information storage unit 121, a state information storage unit 122, a general information storage unit 123, a content attribute information storage unit 124, and a constraint function storage unit 125.

A principal operation of the program table creation device 100 shown in FIG. 1 can be conducted through the use of a program (software) to be executed by a CPU (Central Processing Unit). For example, the program table creation device 100 shown in FIG. 1 is realizable through the use of various types computers including fixedly installed type PC (Personal Computer), notebook type portable PC, PDA and portable telephone, vehicle-mounted device installed in a mobile object such as vehicle, and dedicated terminal carrying a CPU.

In addition, for example, at the creation of a program table, the respective means including the constraint condition learning unit 102, the constraint condition generation unit 103, the constraint condition solution unit 104, the constraint condition priority acquisition unit 105 and the score setting unit 106 are realizable in a manner such that the CPU executes a predetermined program. Still additionally, in particular, the processing for the constraint solution which is a feature of the present invention and is one of artificial intelligence element technologies can employ a technique for constraint logical programming (equally referred to as constraint programming or constraint logic programming) according to a combination of a problem solution based on constraint with logical programming. That is, it is possible to employ a method of solving a constraint problem, described in a declaratory fashion through the use of a constraint logical programming language with a high description capability, by means of a computer.

Still additionally, each of blocks forming components of the program table creation device 100 shown in FIG. 1 can also be located in a distributed fashion. That is, it is also appropriate that the respective blocks are disposed in the same apparatus so that data is transmitted through internal buses or the like within the apparatus between the respective blocks, or that the respective block are placed in fully different apparatus so that data is transmitted through wire cables or wireless transmission mediums between the respective blocks. Therefore, it is also possible that, for example, a program table creation server including the constraint condition solution unit 104, the constraint condition priority acquisition unit 105, the score setting unit 106 and the content information acquisition unit 107 exists on a network while a content information storage server having content attribute information exists as another server on the network so that a user transmits a predetermined constraint condition to the program table creation server through the use of a PC or the like (it is also acceptable that, when needed, the user additionally transmits user-side history information, situation information and others properly) for receiving a program table from the program table creation server.

The constraint condition input unit 101 serves as an input interface for a user, realizable by a GUI (Graphical User Interface) or the like. The user can input a condition of a composition of a program. In this connection, it is preferable that, for simplifying the operations by the user, the condition input using this GUI is capable of achieving a selection of a predetermined condition (for example, selection of classification of contents), a selection of a ratio (for example, selection of ratio of classification of contents or the like included in a program) and others.

The constraint condition learning unit 102 serves as a means to learn the user's liking and tendency on the basis of the condition inputted by the user and others. In this case, although the liking information, together with history information (information concerned with a simple history of condition input by the user), is stored in the history information storage unit 121, it is also acceptable that a user's liking information storage unit, not shown, is separately provided to store the liking information therein. Moreover, the constraint condition learning unit 102 can also acquire a skip rate of contents (the degree of contents the user skips without playing the contents) played by the program playing unit 110 which will be mentioned later, or acquire the user's satisfaction level on a program after the program table output or after the program playing so as to feedback the user's satisfaction level based on a created program table for modifying the user's liking information.

The constraint condition generation unit 103 acts as a means to describe a constraint condition according to a constraint condition description function on the basis of a condition inputted from the constraint condition input unit 101 by the user or a condition related to the user, such as user's liking information supplied by the constraint condition learning unit 102. That is, this constraint condition generation unit 103 reads out a constraint condition description function corresponding to a condition related to the user from the constraint function storage unit 125 storing a large number of constraint condition description functions defined in advance and replaces the condition related to the user with a description according to the constraint condition description function. Accordingly, the information produced by the constraint condition generation unit 103 is obtained by translating the condition related to the user into the constraint condition description function. Incidentally, it is also possible that the constraint condition input unit 101 is not used as a supplier of constraint conditions supplied to the constraint condition generation unit 103, which can completely omit the constraint condition input operation by the user and can realize the automatic program table creation processing based on the constraint condition supplied from the constraint condition learning unit 102.

Each of the constraint condition description functions stored in the constraint function storage unit 125 is a function in which constraints such as time period (length), time (start time and end time), frequency, cycle and sequence with respect to hierarchical corners or contents which components of a program are described in a declaratory fashion. The constraint function storage unit 125 stores constraint condition description functions related to various conditions.

The constraint condition solution unit 104 acts as a means to carry out the creation processing for a program table, which utilizes a constraint solution technique. The constraint condition solution unit 104 receives the information on a condition related to the user, expressed by a constraint condition description function, from the constraint condition generation unit 103 to, as it is an issue to be solved, conduct processing to search a constraint satisfaction solution for releasing (satisfying) the constraint condition. That is, the constraint condition solution unit 104 carries out the processing to find an optimal program table (time schedule of contents) satisfying the constraint condition in consideration of various conditions (attributes of the contents) of the respective contents which can be arranged in a program, with the optimal program table being created and outputted.

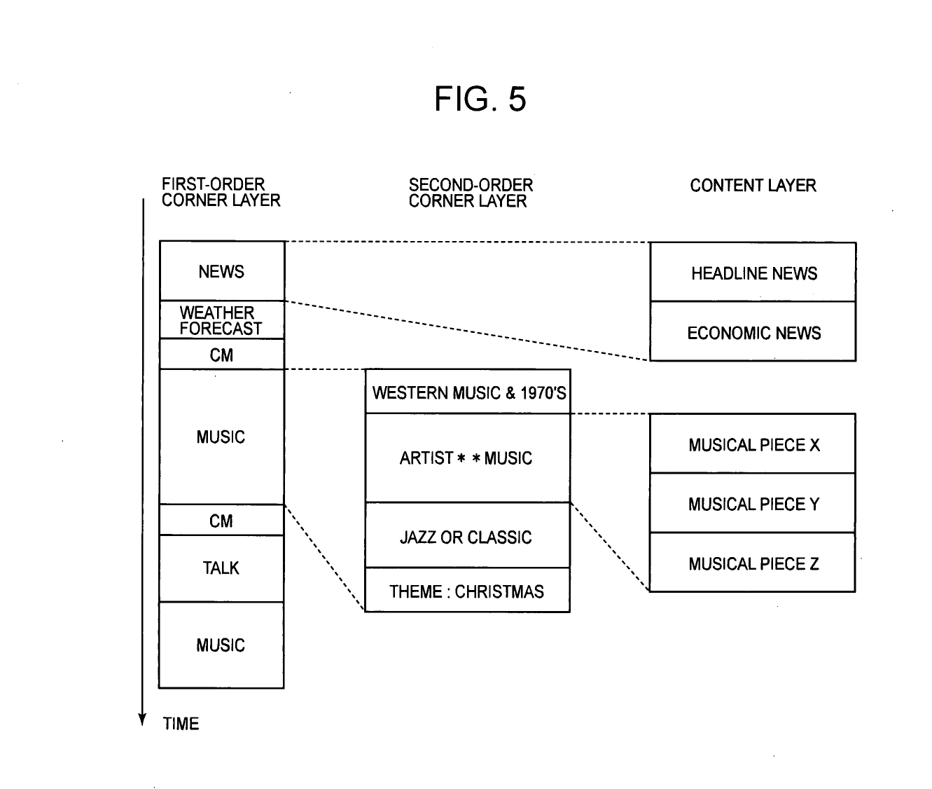

A program is one big unit defined by time, concept and others. The program includes one or a plurality of corners categorized according to a predetermined rule. Moreover, the corner includes one or a plurality of contents, each of which forms a minimum component of a program. That is, the “program”-“corner”-“contents” form a hierarchical structure. For example, referring to FIG. 5, a description will be given of a hierarchical relationship among the above-mentioned program, corner and contents.

As shown in FIG. 5, one program is composed of corners of news, weather forecast. CM, music, CM, talk and music (first-order corner layer) along a time axis. Moreover, the music corner interposed between CMs includes Western music & 1970's corner, artist ** music corner, jazz or classic corner and theme: Christmas corner (second-order corner layer) and, for example, the artist ** music corner is composed of three contents of musical piece X, musical piece Y and musical piece Z (content layer). Still moreover, the news corner includes contents of headline news and economic news. Likewise, the other corners constituting the first-order corner layer are associated through multi-stage corner layers with the contents to be played, or like the news corner shown in FIG. 5, they are directly associated with the contents. Therefore, the playing of one program is achieved by playing the contents arranged in content layers along the time axis.

The content information acquisition unit 107 serves as a means to acquire, from the content attribute information storage unit 124, the attributes of the contents to which reference is made by the constraint condition solution unit 104 at the constraint solution processing for supplying them to the constraint condition solution unit 104. Moreover, the content information acquisition unit 107 can also acquire the general information (signifying statistical data on the respective contents, such as degree of popularity of general public, degree of popularity in time zone and season, tendency of these popularity according to age • sex • occupation, etc.) stored in the general information storage unit 123 for supplying it to the constraint condition solution unit 104.

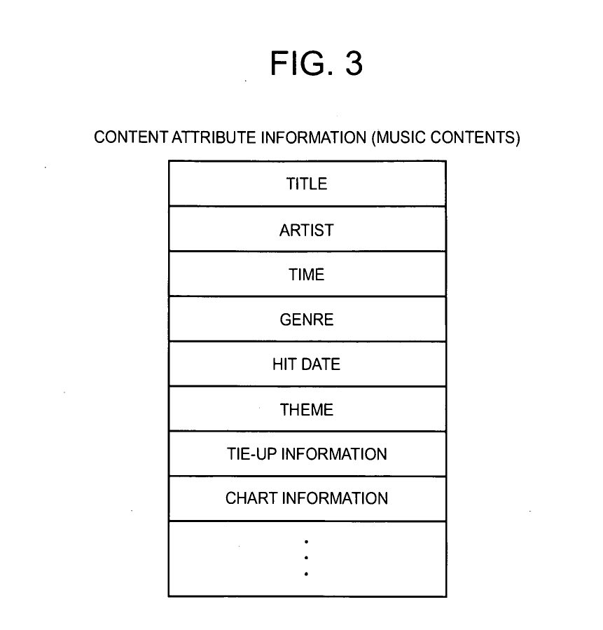

In addition, the content attribute information storage unit 124 stores the information (content attribute information) about the attributes of the respective contents available as a portion of the program as mentioned above. For example, FIG. 3 shows an example of content attribute information on the music contents. As shown in FIG. 3, in a case in which the contents are music contents, in each of the contents, the content attribute information including title of that musical piece, artist, time (content playing time), genre (various classifications such as Japanese music, Western music, jazz, rock, pop), hit date, theme (various information such as Christmas songs, slow/up tempo music), tie-up information (information on cooperation with other media such as television and radio), chart information (history information on hit charts) and others are associated with each other in advance, and these information are stored in the content attribute information storage unit 124.

FIG. 3 shows one example of content attribute information, and all the information shown in FIG. 3 are not always necessary, and information other than the information shown in FIG. 3 can also be set as the content attribute information. Moreover, for example, in the case of the music contents, a CDDB (CD Database) storing the information such as the title and artist of each of the contents can also be employed so as to acquire the content attribute information from this CDDB. Still moreover, also in a case in which the classifications of contents are classifications (for example, diversified classifications such as news, talk, weather forecast and drama) other than the music, the information needed at the constraint solution processing by the constraint condition solution unit 104 is required to be stored as the content attribute information in the content attribute information storage unit 124. Yet moreover, for example, with respect to the content attribute information such as genre and age, the details of items can also be expressed in a manner such that values determined according to a given rule are set, such as Western music=“3” and 1970's=“5”.

Furthermore, in the constraint solution processing by the constraint condition solution unit 104, there arise a constraint shortage state in which a plurality of solutions (program table) satisfying a constraint condition exist and an over-constraint (constraint excess) state in which the number of constraint conditions becomes excessively large (that is, the constraint condition is too limited) so as to make it difficult to find the optimal solution. For coping with these states, there are provided the constraint condition priority acquisition unit (constraint excess handling unit) 105 and the score setting unit (constraint shortage handling unit) 106.

The constraint condition priority acquisition unit 105 serves as a means to, when a solution satisfying the constraint condition is not derived in a constraint excess state, set a priority with respect to a constraint condition (constraint solution description function) for assisting the derivation of the optimal solution in the constraint solution processing. For example, the constraint condition priority acquisition unit 105 can carry out weighting or set a priority with respect to each constraint condition on the basis of the user's history information or liking information stored in the history information storage unit 121, the state information (information on various states such as present position acquired by the GPS (Global Positioning System), present time, television/radio program table at that time, condition • situation of service provider or content provider, condition received from other person • other persons, weather situation, road situation or presence or absence of fellow passenger when it exists in the interior of a vehicle) stored in the state information storage unit 122, the general information stored in the general information storage unit 123. Thus, the constraint condition solution unit 104 can carry out the constraint solution processing in consideration of the weight given to each constraint condition or conduct the constraint solution processing to preferentially a constraint condition set to be higher in priority.

In this connection, it is also possible that the user personally sets the priority, which is to be set by the constraint condition priority acquisition unit 105, through the use of an input interface of the constraint condition input unit 101. Moreover, in this case, although the constraint condition priority acquisition unit 105 sets a priority with respect to each constraint condition, it is also possible that the constraint condition priority acquisition unit 105 sets a priority with respect to each content (or content attribute information).

The score setting unit 106 serves as a means to assist the derivation of the optimal solution in the constraint solution processing by setting a score with respect to each content. Concretely, the score setting unit 106 sets scores with respect to all the contents constituting a plurality of solutions (program table) satisfying a constraint condition and then supplies the scores to an objective function calculation unit 111, which is made to calculate an objective function in a state where the scores are set as parameters, for calculating an objective function so that the ranks of a plurality of program tables satisfying the constraint condition are determined on the basis of a result of the calculation. The information on this ranking is supplied from the score setting unit 106 to the constraint condition solution unit 104 so that the constraint condition solution unit 104 can output, as an optimal program table(s), a solution(s) (one or a plurality of program tables) forming a portion of the plurality of solutions discriminated on the basis of the ranking information, which exist at higher rank positions.

In addition, as well as the above-mentioned constraint condition priority acquisition unit 105, the score setting unit 106 can set a score with respect to each content on the basis of the user's history information or liking information, the state information, the general information, and others. Thus, the constraint condition solution unit 104 can calculate the values of objective functions with the aforesaid scores being set as parameters for making a comparison between the calculation results, thereby making a discrimination among the plurality of program tables.

In this connection, it is also possible that the user personally sets a score, which is to be set by the score setting unit 106, through the use of the input interface of the constraint condition input unit 101. Moreover, in this case, although the score setting unit 106 sets a score with respect to each content, it is also possible to set a score with respect to each constraint condition (each constraint condition description function).

In a case in which the constraint condition solution unit 104 carries out the constraint solution processing on the basis of the above-mentioned assistance by the constraint condition priority acquisition unit 105 or the score setting unit 106, the plurality of program tables are ranked in process of obtaining the optimal program table. The constraint condition solution unit 104 can output only the highest-rank program table which is one of the program tables thus obtained and can also output the program tables (for example, three program tables) each having a rank higher than a predetermined rank (for example, three program tables higher in rank).

The optimal program created by the constraint condition solution unit 104 is supplied to the program table output unit 108 and the content acquisition unit 109. For example, the program table output unit 108 is a monitor for outputting video information, a speaker for outputting audio information, or the like, and the fact that a program table has been created or the program table itself is notified from the program table output unit 108 to the user. Moreover, in the case of the constraint shortage or the constraint excess, a plurality of program tables are outputted as candidates for selection from the program table output unit 108 so that the user can make a selection. Still moreover, the program table output unit 108 can also be a means to write information in a predetermined recording medium or communication means so that, through the program table output unit 108, a program table is recorded in the predetermined recording medium or transmitted to other communication apparatus or networks.

The content acquisition unit 109 serves as a means to acquire the contents on the basis of the program table created by the constraint condition solution unit 104. The content storage place (content acquired place) from which the content acquisition unit 109 acquires the contents can be set arbitrarily. That is, the content available as a component of a program is not limited particularly, and it is possible to utilize arbitrary contents including contents broadcasted by a broadcast signal, contents delivered through a network and local contents (contents stored in a CD or DVD). The contents acquired by the content acquisition unit 109 are video-played or audio-played in the program playing unit 110.

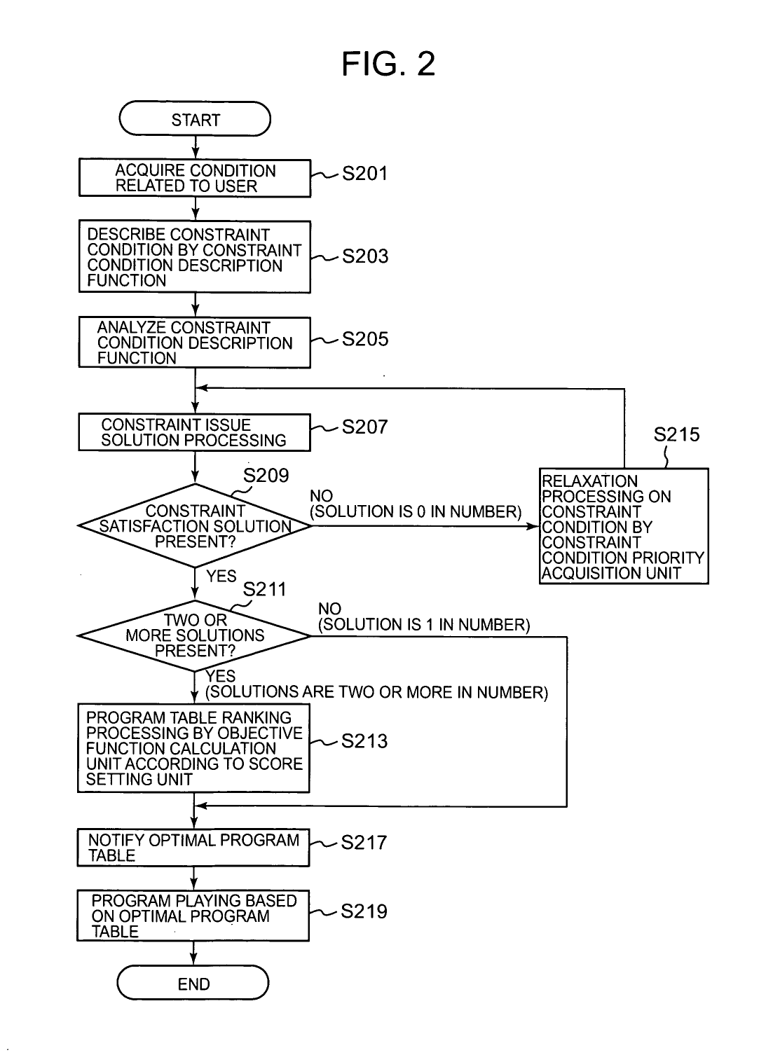

Referring to FIG. 2, a description will be given hereinbelow of the outline of an operation according to an embodiment of the present invention. FIG. 2 is a flow chart showing one example of a program table creation method according to an embodiment of the present invention. In this case, a description of the flow chart shown in FIG. 2 will be given on the basis of the program table creation device 100 shown in FIG. 1.

For carrying out the program table creation processing, first, the constraint condition generation unit 103 acquires a condition inputted by a user and a condition related to the user, such as user's liking information, from the constraint condition input unit 101, the constraint condition learning unit 102 or the like (step S201), and describes a constraint condition(s) through the use of a constraint condition description function on the basis of these conditions (constraint conditions) (step S203). The constraint condition solution unit 104 carries out the constraint solution processing on the basis of the constraint condition description function describing the constraint condition.

In the constraint solution processing by the constraint condition solution unit 104, the constraint condition solution unit 104 first analyzes the constraint condition description function (step S205). Moreover, the constraint condition solution unit 104 carries out the constraint issue solution processing based upon the constraint solution technique to obtain all program tables (constraint satisfaction solutions), which satisfy the constraint condition without contradiction, while making reference to the content attribute information in the content attribute information storage unit 124 through the content information acquisition unit 107 (step S207). As the simplest algorithm, for example, there is a method of automatically making a judgment on a value releasing a contradiction by conducting a search based on backtrack. However, in the constraint condition solution unit 104, the constraint issue solution algorithm is not limited particularly.

In the constraint issue solution processing based upon the constraint solution technique, for example, the selection of contents and the determination of sequence of disposition of contents can be made by making reference to the following conditions. For example, only the contents whose scores set with respect to the contents exceed a predetermined threshold can be selected so that the constraint issue solution processing is conducted through the use of only the contents exceeding the predetermined threshold.

If only the contents having high scores are always selected, since the program table created always becomes the same, the selection of contents can also be made at random. For example, the selection of contents can be made so that contents whose scores set with respect to the contents exceed a predetermined threshold are included by a predetermined rate, thereby carrying out the constraint issue solution processing by use of the contents thus selected. Moreover, for example, it is also possible that an integration result obtained by integrating a random value with respect to a score set for a content is considered as a new score so as to select a content whose new score exceeds a predetermined threshold, or the contents selection is made so that the contents whose new scores exceed the predetermined threshold are included by a predetermined rate, thereby carrying out the constraint issue solution processing through the use of the contents thus selected.

In addition, with respect to the disposition sequence of contents, it is also possible to consider the positions in each corner where the contents having high scores are to be disposed or to determine the disposition positions while considering the correlation between the contents adjacent to each other. For example, for this determination of disposition sequence of contents, in each corner, the contents having high scores are disposed at the beginning portion and/or end portion of the corner or at an intermediate portion of the corner or disposed in consideration of a flow of the entire corner so that the correlation between the attributes of the respective contents reaches a maximum, thus optimizing the disposition sequence of contents. The optimization of the disposition sequence of contents will be described in detail later. Moreover, the optimization of the disposition sequence of contents can be made in process of the creation of a program table (for example, step S207) or it can also be made after the constraint issue solution processing (before the notification on an optimal program table in the step S217).

Furthermore, in the constraint issue solution processing based upon the constraint solution technique in the step S207, it is expectable that any one of the following three results (first to third results) occurs (steps S209 and S211). The first result shows a state in which only one constraint satisfaction solution is found. The second result shows a state in which two or more constraint satisfaction solutions are found due to a constraint shortage. The third result shows a state in which no constraint satisfaction solution is found due to constraint excess (constraint satisfaction solution is zero in number).

In the case of the first result indicative of only one constraint satisfaction solution being found, the constraint condition solution unit 104 determines this constraint satisfaction solution as an optimal program table to be provided to the user, and advances to a step S217, mentioned later, for notifying the optimal program table to the user.

In the case of the second result indicative of two or more constraint satisfaction solutions being found, the objective function creation unit 111 carries out the program table ranking processing on the basis of the score setting unit 106 (step S213). In the processing of this step S213, for example, the constraint condition solution unit 104 makes a request to the score setting unit 106 for determining scores with respect to the contents and ranking them. At this time, the score setting unit 106 determines a score of each of the contents and makes the objective function calculation unit 111 calculate objective functions with respect to all the program tables (constraint satisfaction solutions) by using the cores as parameters so that the ranks of the respective constraint satisfaction solutions are determined on the basis of the calculation result. Moreover, the constraint condition solution unit 104 refers to this ranking information for outputting, as the optimal program table(s), the constraint satisfaction solution existing at the highest rank position or a plurality of constraint satisfaction solutions existing at higher rank positions.

In the case of the third result indicative of no constraint satisfaction solution being found, the constraint condition priority acquisition unit 105 acquires a priority set with respect to the constraint condition used in the constraint issue solution processing of the step S207 and deletes a constraint condition with a low priority and then conduct the processing to re-supply the remaining constraint condition to the constraint condition solution unit 104 (step S215: constraint condition relaxation processing by the constraint condition priority acquisition unit). That is, in the processing of the step S215, a portion of the constraint conditions are deleted so as to relax the constraint condition when obtaining the constraint satisfaction solution. Subsequently, the operation returns to the step S207 to further carry out the constraint issue solution processing on the basis of the relaxed constraint condition.

Concretely, a plurality of stages of priorities (for example, four stages of priorities “essential”, “strong”, “common” and “weak”) are set with respect to the constraint conditions in advance, and in the constraint issue solution processing (step S207) to be first conducted, the constraint satisfaction solutions satisfying the constraint conditions for all the priorities are searched. Moreover, if a constraint satisfaction solution is not found in this first constraint issue solution processing (solution is 0 in number), the constraint condition having the lowest priority (“weak”) is deleted in the processing of the step S215, and the constraint conditions having the priorities (“essential”, “strong”, “common”) other than “weak” are set as new constraint conditions so that the second constraint issue solution processing (step S207) is again conducted on the basis of the new constraint conditions.

In a case in which no constraint satisfaction solution is found even in this second constraint issue solution processing, the priority for the constraint condition to be deleted is increased to delete the constraint condition of “common”, and the constraint conditions for the priorities of two stages of “essential” and “strong” are set as new constraint conditions so that the third constraint issue solution processing (step S207) is a gain conducted on the basis of the new constraint conditions. Moreover, if no constrain satisfaction solution is found even in this case, the constraint condition with the priority of “strong” is deleted, and the constraint condition for only the priority of “essential” is set as a new constraint condition so that the third constraint issue solution processing (step S207) is again conducted on the basis of this new constraint condition.

When the constraint condition relaxation is made stepwise in this way, at the time that one or a plurality of constraint satisfaction solutions are found, the operation advances to the processing after the above-mentioned step S211 so as to conduct the processing when a constraint satisfaction solution(s) exists. Moreover, in a casein which no constraint satisfaction solution is found even in the constraint issue solution processing conducted when the priority is extremely relaxed (for example, in the above-mentioned case, the constraint condition for only the priority of “essential”), the program table output unit 108 can also notify the fact that a constraint satisfaction solution (optimal program table) satisfying the constraint condition does not exist. Although the four stages of priorities of “essential”, “strong”, “common” and “weak” are previously set in the above-mentioned example, the priority setting mode, the number of stages of priorities and others can be set arbitrarily.

In addition, in a case in which one or a plurality of constraint satisfaction solutions are found, this constraint satisfaction solution(s) is outputted as the optimal program table from the constraint condition solution unit 104 to the program table output unit 108 or the content acquisition unit 109 so as to carry out the notification of the optimal program table (step S217) or the playing (program playing) of the contents based on the optimal program table (step S219). At this time, it is preferable that the user performs the confirmation work or selection work with respect to the optimal program table notified from the program table output unit 108.

A detailed description will be given hereinbelow of each of a condition related to a user, which is acquired by the constraint condition generation unit 103 of the program table creation apparatus 100 according to an embodiment of the present invention, and a program table created by the constraint condition solution unit 104.

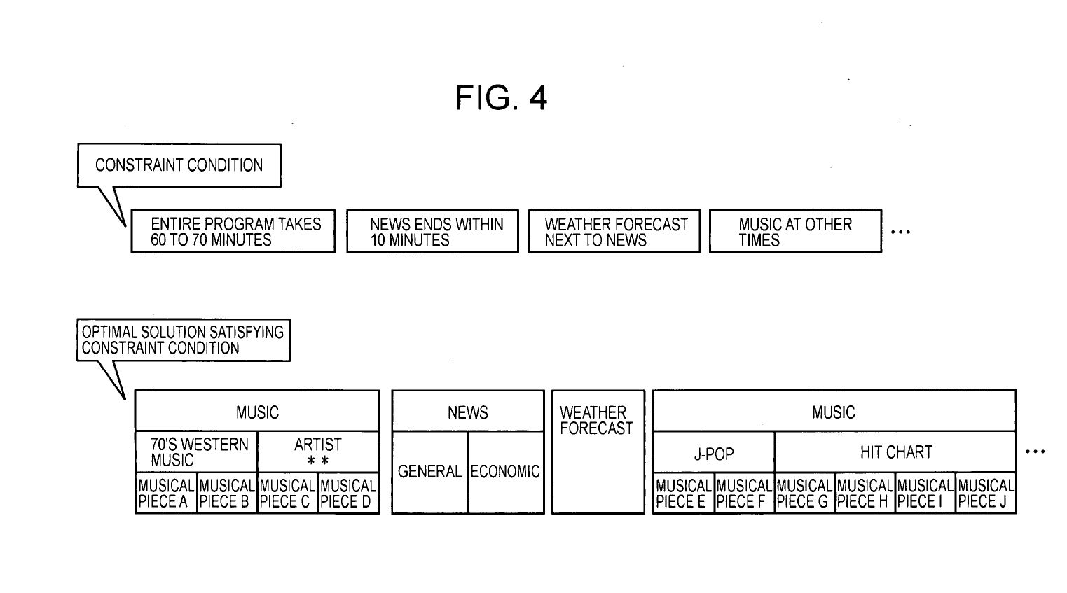

FIG. 4 is an illustrative view showing one example of a constraint condition to which reference is made at a creation of a program table according to an embodiment of the present invention and one example of an optimal solution derived on the basis of this constraint condition. At a creation of a program table, the constraint condition generation unit 103 receives a supply of a constraint condition, for example, shown in FIG. 4 as a condition related to a user. FIG. 4 shows, as one example of a constraint condition, a condition (condition related to the time of the entire program) that one program takes 60 to 70 minutes as a whole, a condition (condition related to the length of a corner) that a news comes to an end within 10 minutes, a condition (condition related to the sequence of corner or contents) that a weather forecast is inserted next to a news and a condition (condition related to genre) that music is passed at all other times.

Various conditions can be set in addition to the constraint condition shown in FIG. 4. Moreover, a detailed constraint condition can be set such that, for example, “music corner” is placed next to “news corner”, one “music corner” takes a time longer than 60 minutes but shorter than 70 minutes, “music corner” includes “Western music corner” and “Japanese Music corner” which take a time longer than 40 minutes but shorter than 50 minutes and a time longer than 20 minutes but shorter than 30 minutes, respectively, “Western music corner” includes “1970's corner” and “latest hit corner” each of which takes approximately one-half, and “1970's corner” always includes one musical piece [symbol] of artist ••.

In addition, FIG. 4 shows one example of an optimal solution satisfying a constraint condition, derived by the constraint condition solution unit 104 on the basis of the above-mentioned constraint condition. This optimal solution equals an optimal program table (time schedule of programs) created in a manner such that the constraint condition solution unit 104 specifies the types of hierarchical corners and the contents included in the corners and, except the constraint excess, all the constraint conditions are basically satisfied. In the case of the constraint excess, a priority is set with respect to each constraint condition as mentioned above, thereby deriving an optimal solution at the sacrifice of one or a plurality of constraint conditions having low priorities. Moreover, the optimal solution shown in FIG. 4, satisfying the constraint condition, has the same structure as the structure to which reference is made for the description of the hierarchical relationship among the programs, corners and contents.

For the creation of the optimal program table shown in FIG. 4, as a method of specifying the hierarchical corners, for example, the constraint condition solution unit 104 can employ a logical expression on a value of each attribute of each content. That is, for example, a content included in “Western music & 1970's corner” of the music corner is specified through an AND operation of two values of “genre name=Western music” and “date=1970's” of the attributes the music contents have.

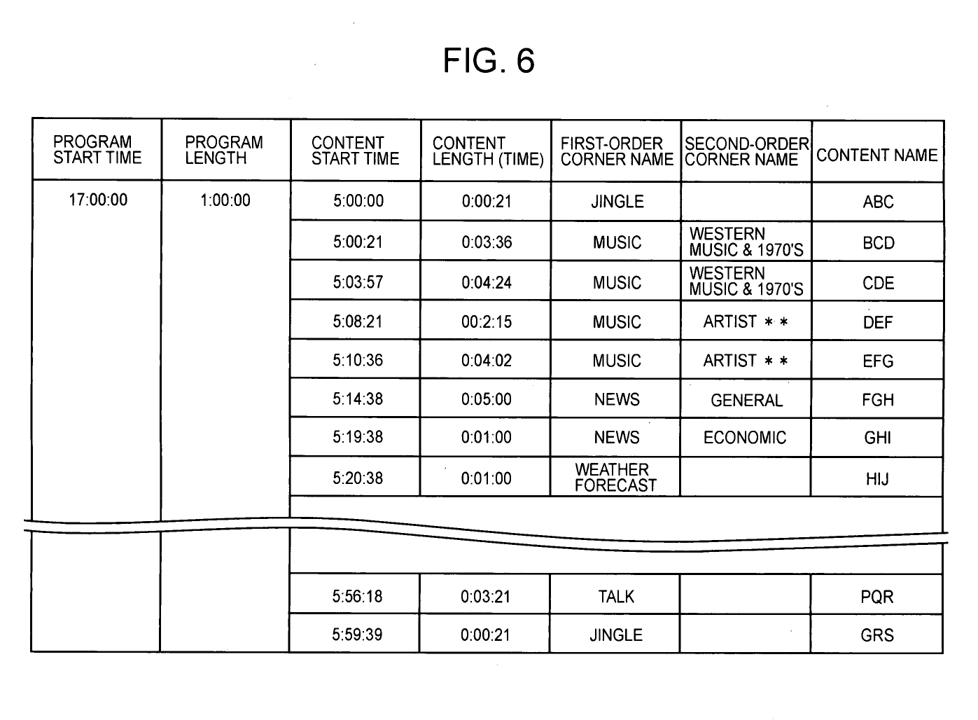

FIG. 6 is an illustrative view showing one example of a program table to be created finally by a program table creation device according to an embodiment of the present invention. FIG. 6 is an illustrative view showing one example of an optimal program table created by additionally imposing a constraint condition of one-hour program from 17 o'clock to 18 o'clock. In this case, the content start times indicative of the playing start timings of the respective corners or the respective contents are defined along with the names of corners and contents (in FIG. 6, as one example, the names of contents are written with three letters of the alphabet in a proper fashion) constituting a program. In the content name column, the information including position information and identification information for acquisition of these contents are written, and the content acquisition unit 109 refers to this information to acquire the contents so that the program playing unit 110 can play the contents at a predetermined playing start timing.

In addition, after the creation of the program table mentioned above, it is also possible that a portion of a program (a portion of corners or a portion of contents) is re-disposed while satisfying the constraint condition imposed in process of the creation of the program table, thus carrying out the optimization so that the program table optimized is outputted as a final program table. The optimization (the optimization of the disposition sequence of corners or contents) after the this program creation is for coping with the user side needs that he/she wants to listen to contents in a corner or program in a state shuffled, and the re-disposition of a portion of a program provides an advantageous effect that the user's estimation increases with respect to the entire program.

As method of shuffling a portion of a program in a range satisfying a constraint condition, some methods are considerable. The simplest method is a method of shuffling the corners or contents of a created program at random in a range satisfying the constraint condition.

Moreover, it is effective that the contents a user is most likely to listen to are disposed at a place in a corner (relative position in a corner). This is for coping with, for example, the needs that a user wants to listen to his/her favorite musical piece at the beginning and/or end of a music corner or in the middle of the music corner and, when consideration is thus given to the playing timings of the user's favorite contents, an advantageous effect that the user's estimation increases with respect to the entire program is attainable.

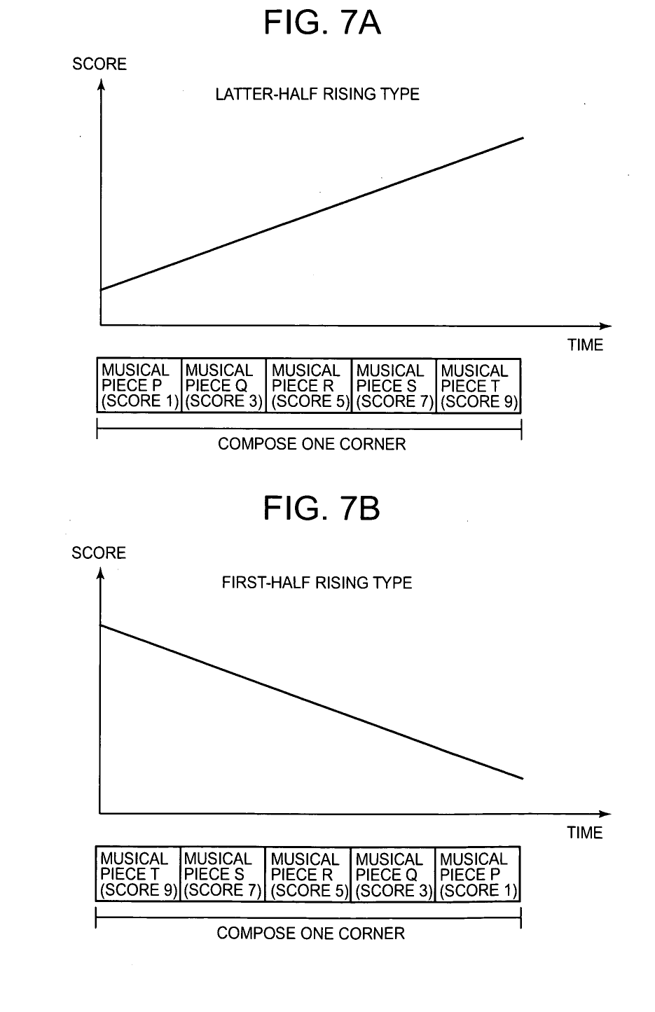

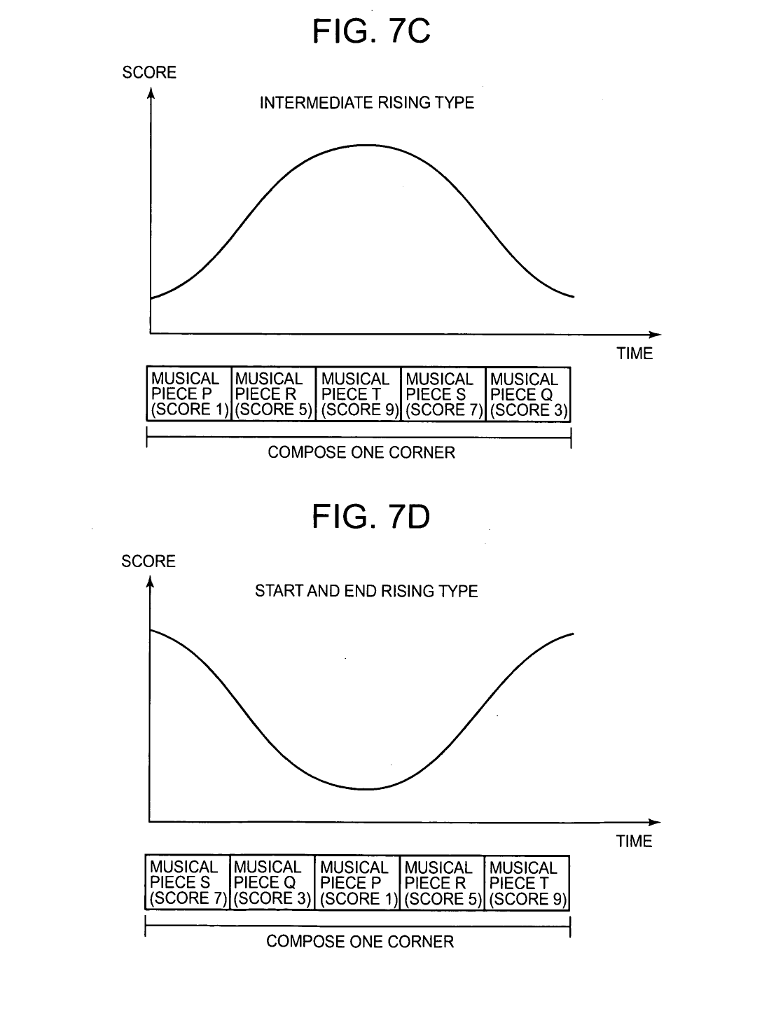

As methods of rearranging a portion of a program in a range satisfying a constraint condition in consideration of the playing timings of the user's favorite contents, the following four types are considerable. These four methods will be described with reference to FIGS. 7A to 7D.

FIG. 7A is an illustration of a first example of the disposition optimization on contents in a corner according to an embodiment of the present invention. Each of the contents included in a program after created has a score set in process of a program creation. As mentioned above, this score is the information which can be set with respect to each of the contents on the basis of user's history information and liking information, state information, general information and others, that is, it is an integrally expressed numerical value of the user's history and liking, a situation at the playing of a program, a general popularity level and others.

FIG. 7A shows the relationship between time and score which are to be referenced when recording a plurality of contents in a corner while satisfying a constrain condition. For example, when a plurality of contents are rearranged in a corner, as shown in FIG. 7A, contents with higher scores are disposed toward the latter half of the corner. Therefore, the contents recording method shown in FIG. 7A can be referred to as a latter-half rising type (ascending order pattern).

For example, let it be assumed that a corner including five musical pieces (“musical piece P” to “musical piece T”) exists and the score of “musical piece P” is 1, the score of “musical piece Q” is 3, the score of “musical piece R” is 5, the score of “musical piece S” is 7, and the score of “musical piece T” is 9. In the case of rearranging these five musical piece contents, when reference is made to each of the musical piece contents so as to dispose them into the latter-half rising type shown in FIG. 7A, the sequence of the musical piece contents included in this corner is optimized into “musical piece P”, “musical piece Q”, “musical piece R”, “musical piece S” and “musical piece T”.

Moreover, FIG. 7B is an illustration of a second example of the disposition optimization on contents in a corner according to an embodiment of the present invention. For example, when a plurality of contents are rearranged in the corner, as shown in FIG. 7B, the contents with higher scores are disposed at the first half portion of the corner. Accordingly, the contents rearranging method shown in FIG. 7B can be referred to as a first-half rising type (descending order pattern).

For example, let it be assumed that a corner including five musical pieces (“musical piece P” to “musical piece T”) exists and the score of “musical piece P” is 1, the score of “musical piece Q” is 3, the score of “musical piece R” is 5, the score of “musical piece S” is 7, and the score of “musical piece T” is 9. In the case of rearranging these five musical piece contents, when reference is made to each of the musical piece contents so as to dispose them into the first-half rising type shown in FIG. 7B, the sequence of the musical piece contents included in this corner is optimized into “musical piece T”, “musical piece S”, “musical piece R”, “musical piece Q” and “musical piece P”.

Still moreover, FIG. 7C is an illustration of a third example of the disposition optimization on contents in a corner according to an embodiment of the present invention. For example, when a plurality of contents are rearranged in the corner, as shown in FIG. 7C, the contents with higher scores are disposed at an intermediate portion of the corner. Accordingly, the contents rearranging method shown in FIG. 7C can be referred to as an intermediate rising type (mount-like pattern).

For example, let it be assumed that a corner including five musical pieces (“musical piece P” to “musical piece T”) exists and the score of “musical piece P” is 1, the score of “musical piece Q” is 3, the score of “musical piece R” is 5, the score of “musical piece S” is 7, and the score of “musical piece T” is 9. In the case of rearranging these five musical piece contents, when reference is made to each of the musical piece contents so as to dispose them into the intermediate rising type shown in FIG. 7C, the sequence of the musical piece contents included in this corner is optimized into “musical piece P”, “musical piece R”, “musical piece T”, “musical piece S” and “musical piece Q”.

Yet moreover, FIG. 7D is an illustration of a fourth example of the disposition optimization on contents in a corner according to an embodiment of the present invention. For example, when a plurality of contents are rearranged in the corner, as shown in FIG. 7D, the contents with higher scores are disposed at the beginning and end portions of the corner. Accordingly, the contents rearranging method shown in FIG. 7D can be referred to as a start and end rising type (valley-like pattern).

For example, let it be assumed that a corner including five musical pieces (“musical piece P” to “musical piece T”) exists and the score of “musical piece P” is 1, the score of “musical piece Q” is 3, the score of “musical piece R” is 5, the score of “musical piece S” is 7, and the score of “musical piece T” is 9. In the case of rearranging these five musical piece contents, when reference is made to each of the musical piece contents so as to dispose them into the start and end rising type shown in FIG. 7D, the sequence of the musical piece contents included in this corner is optimized into “musical pieces”, “musical piece Q”, “musical piece P”, “musical piece R” and “musical piece T”.

In addition, it is also effective that the rearrangement of contents is made in consideration of the correlation between contents in a corner. This can provide an advantageous effect of smoothing the flow of the entire program by disposing, immediately after one content, a different content judged as being similar thereto because of having a high correlation about the content attribute including the genre, artist, date and music tone.

For example, when a decision is made on a correlation about each of K contents constituting one corner, for example, marks are given to correlation about the genre, artist, date, music tone and others of each of the K contents. For example, marks are previously defined with respect to variables entering the attributes such that, with respect to the genre, 8 points out of a possible 10 when classic is disposed after jazz, and with respect to the music tone, 2 points out of a possible 10 when slightly noisy music tone is disposed after soft music tone, thereby enabling giving marks representative of the correlation among attributes. Moreover, with respect to each of the dispositions (K kinds) of the K contents, the sum total of marks indicative of the correlation among the respective attributes is calculated so that the contents disposition showing the highest calculation result is considered as a contents disposition which can provide the smoothest flow of the contents in the corner.

In this connection, with respect to the scores of the contents, there are a case in which they are determined by contents themselves and a case in which they are determined dynamically depending on the contents existing before and after. Moreover, the scores of the contents can dynamically be changed according to situations or the like. Still moreover, although in the above-mentioned example the disposition of the contents is optimized using the scores of the contents, it is also possible that the disposition of the contents is optimized by, for example, attribute correlation (content based filter) or contents correlation (cooperation filter).

Furthermore, a concrete description will be given of one example of a constraint solution processing algorithm according to an embodiment of the present invention. According to the present invention, for example, as shown in FIG. 4 and FIG. 5, by utilizing the hierarchical relationship among a program, corners and contents, a constraint condition defined in each hierarchy can be introduced into the upper and/or lower hierarchies, thereby enabling efficient constraint solution processing.

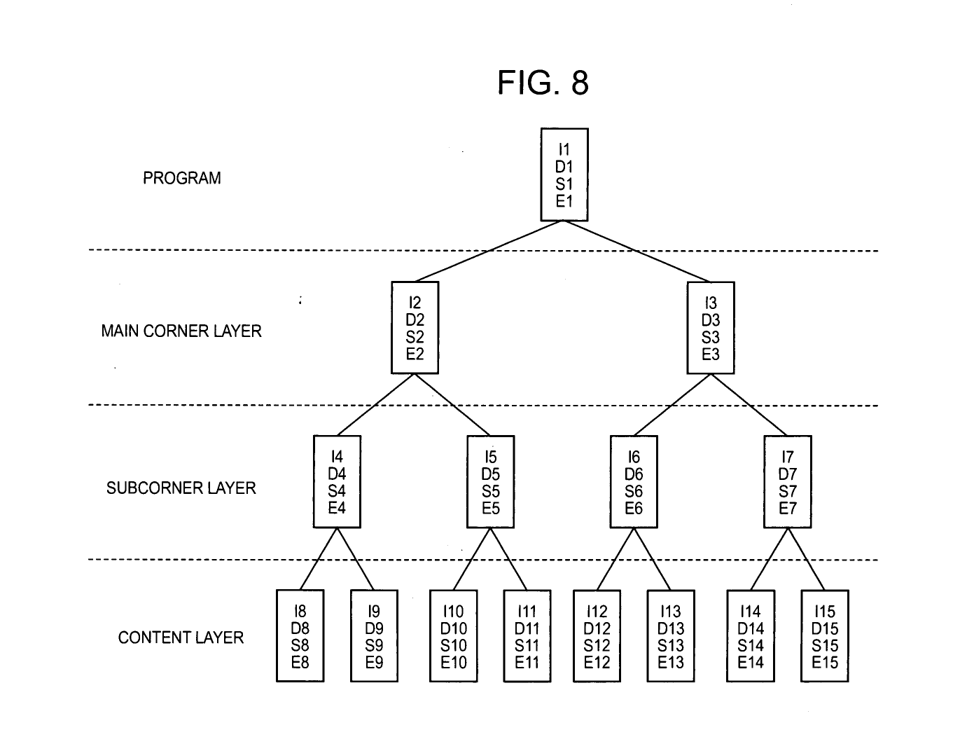

First, referring to FIG. 8, a description will be given of the concept of a tree structure to be used for the constraint solution processing according to an embodiment of the present invention. FIG. 8 is an illustrative view showing the concept of the tree structure for use in the constraint solution processing according to the embodiment of the present invention. Although FIG. 8 shows a tree structure having two corner hierarchies (main corner layer and subcorner layer: corresponding to the above-mentioned first-order corner layer and second-order corner layer), one hierarchy or three or more hierarchies are also acceptable as the corner layers.

As shown in FIG. 8, one program is composed of a main corner layer indicative of a major classification such as music, news, CM and weather forecast, a subcorner layer satisfying the attribute of the main corner layer and constituting a layer just under the main corner layer and a content layer forming a minimum component constituting the program, and this relationship can be shown by a tree structure. In the following description, each of the components (shown by rectangular configurations in FIG. 8) forming the tree structure will be referred to as an element). Moreover, a line segment between the elements indicates the fact that the upper layer has the attribute of the lower layer, and each of the elements has information indicative of a position of the disposition in the tree structure.

Moreover, in other words, each of the elements shown in FIG. 8 is only a container, and a program table is created when the content attribute information is put in this container. For example, in the constraint solution processing according to the embodiment of the present invention, the element can be expressed by a set of four variables of an index (I1 to I15) for specifying a corner or content put in the element, an element time width (D1 to D15), an element start time (S1 to S15) and a element end time (E1 to E15). Since the determination of the element start time leads to the determination of the element time width, although any one of the element total time, the start time and the end time is redundant information, at the actual calculation, the calculation efficiency is improvable by setting all the information on the element time width, the start time and the end time.

The constraint to be defined between the hierarchies by the tree structure with respect to the element variable is as follows. First, it is required that one element time width is equal to the sum of time widths of a plurality of elements existing just under that element. That is, in the example shown in FIG. 8, for example, D1=D2+D3, D2=D4+D5 and D4=D8+D9.

In addition, it is required that one element start time coincides with the start time of the first element existing just under that element and these start times coincide with the end time of an element positioned immediately before the aforesaid first element. That is, in the example shown in FIG. 8, for example, S1=S2=S4=S8, and S3=S6=E5.

Still additionally, likewise, it is required that one element end time coincides with the end time of the last element immediately under that element and these end times coincides with the start time of an element positioned immediately after the aforesaid last element. That is, in the example shown in FIG. 8, for example, E1=E3=E7=E15 and E2=E5=S6.

Yet additionally, in a case in which an attribute is given to one element, this attribute is introduced into an element(s) positioned just above and/or just under that element. That is, for example, in a case in which an attribute which is a musical piece of an artist ** is constrained with respect to one element of the subcorner layer, a content positioned under that element is constrained by a musical piece content having the attribute of the musical piece of the artist **, and a content positioned above that the element is constrained by a category (for example, music genre) including the attribute of the musical piece of the artist **.

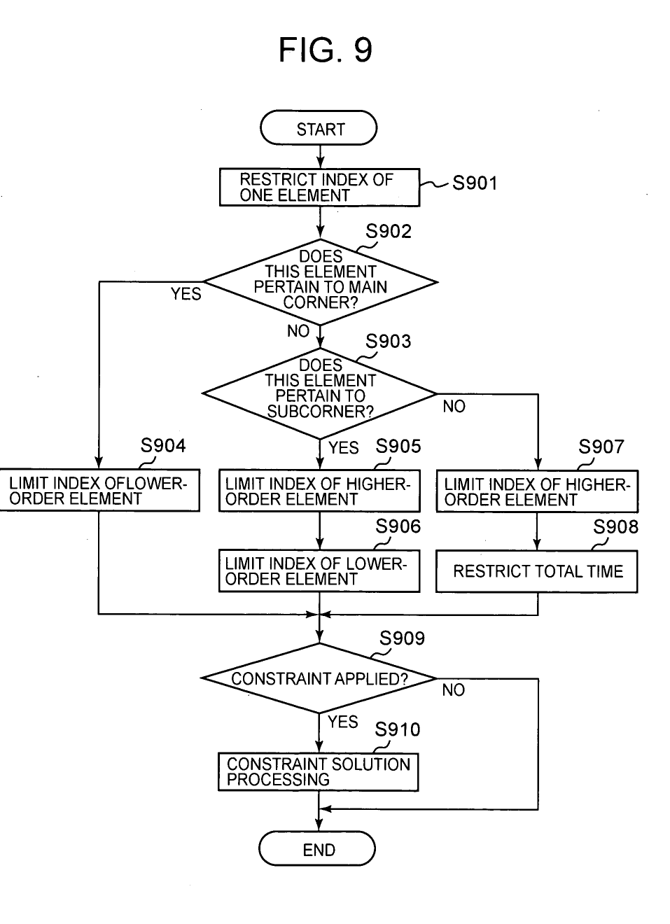

Furthermore, a description will be given of a constraint solution processing algorithm using the tree structure shown in FIG. 8. FIG. 9 is a flow chart showing one example of a constraint solution processing algorithm using the tree structure according an embodiment of the present invention. This flow chart shown in FIG. 9 is detailed processing in the constraint issue solution processing in the step S207 shown in FIG. 2.

The constraint solution processing carries out the processing to determine all the variables (the above-mentioned index, time width, start time, end time) of the respective elements in the tree structure shown in FIG. 8. When the index of each element is determined (that is, the content and the corner to be put in each element are determined), all the other variables are determined, which enables the creation of a complete program table. In this case, referring to FIG. 9, a description will be given of a case in which a limitation on a content which becomes an object of constraint solution processing is made by introducing restrictions in the tree after the determination of an index of one element (after the restriction of a given index).

In FIG. 9, first, an index is put in one element to restrict the index of the element (step S901). In this case, the defined index introduction mode varies according to the hierarchy to which the element where the index is restricted pertains.

Steps S902 and S903 are conducted according to the hierarchy to which the element where the index is restricted pertains. That is, in the flow chart shown in FIG. 9, in a case in which the element where the index is restricted pertains to a main corner, the operation advances to a step S904 and, when the element where the index is restricted corresponds to a subcorner, the operation advances to a step S905 and, when the element where the index is restricted pertains to a content, the operation advances to a step S907.

In a case where the element where the index is restricted pertains to a main corner, a defined index is introduced into an element positioned under this main corner and, in consequence, the index of the lower-order element is limited (step S904). For example, when the main corner is set at a “music corner”, an index to be put in an element of a subcorner positioned just under it is limited to have an attribute such as “1970's corner”, “jazz corner” or “classic corner” which can be disposed just under the “music corner”.

Moreover, in a case in which the element where the index is restricted pertains to a subcorner, a defined index is introduced into both higher-order and lower-order elements relative to this subcorner, thus limiting the indexes of the higher-order and lower-order elements (steps S905 and S906). For example, when the subcorner is set at “Japanese music corner”, the index to be put in the element of a content positioned just under it is limited to have an attribute of a musical piece of a Japanese music artist which can be disposed just under the “Japanese music corner”, and the index to be put in the element of the main corner positioned just above it is limited to, for example, “music corner”.

Still moreover, in a case in which the element where the index is restricted pertains to a content, a defined index is introduced into a higher-order element relative to this content, thus limiting the index of the higher-order element (step S907). For example, when the content is set at “musical piece Z”, the index to be put in the element of the subcorner positioned just above it is limited to have an attribute such as “musical piece of artist **” or “Western music corner” which can be disposed just above the “music piece Z”. Moreover, in this case, since one content is defined, this content is embedded in some portion of the entire program, which newly generates a condition that a portion of the total time of the entire program is satisfied (restricted) by the time width of this content (step S908).

Yet moreover, consideration is given to whether other constraint condition is applied or not (step S909). If the other constraint condition is applied, the constraint solution processing is conducted on the basis of, combined with the other constraint condition, the restrictions in the above-mentioned steps S901 to S908 (step S910), thereby deriving a set of solutions where the constraint conditions are solved.

Furthermore, as the respective constraint conditions for the creation of a program table, for example, one of or a combination of the following constraint conditions is set to carry out the constraint solution processing. For example, a constraint on a start time or end time of an element is made as a constraint condition. For example, a constraint that a news starts after an elapse of 30 minutes from a program start time and ends after an elapse of 40 minutes applies to it.

Still furthermore, a constraint on an element time width is made as a constraint condition. For example, a constraint that a news takes 10 minutes applies to this. Yet furthermore, a constraint on an element sequence constraint is made as a constraint condition. For example, a constraint that a weather forecast is taken immediately after a news.

On the other hand, in a case in which other constraint condition does not exist, a set of solutions satisfying the restriction conditions in the above-mentioned steps S901 to S908 is derived. In this case, the processing according to the flow chart shown in FIG. 9 can be conducted by restriction on a new index or application of a constraint condition.

Although in the above-mentioned method a content which is an object of constraint solution processing is restricted by restricting an index, information set as an initial value is not limited to an index, for example, it is also appropriate that the restriction on a content which is an object of the constraint solution processing is made by making a restriction on an element time width without restricting the index.

Moreover, although there is a need to determine the number of elements, as an algorithm for the determination of the number of elements, an arbitrary algorithm is usable and, in the present invention, it is not limited particularly. Still moreover, although in the flowchart shown in FIG. 9 an algorithm which can determine an index in every hierarchy is shown, it is desirable that, in the actual calculation, an index restriction condition is introduced from a higher-order hierarchy toward a lower-order hierarchy.

Secondly, a description will be given of re-scheduling of a program table. The re-scheduling (rearrangement) of a program table can also be made after the program table is created as described above. This program table re-scheduling can start at an arbitrary timing, and it can start in accordance with an arbitrary trigger such as a re-scheduling instruction from a user through, for example, a user interface, a time prolongation of the entire program (as one example, a case in which a program table creation device according to the present invention is mounted in a vehicle and, although a program table has been created on the basis of an estimated necessary time up to a destination, the estimated arrival time at the destination is delayed due to the influence of the road situation such as traffic jams so as to lengthen the total time of the entire program) or a change of program viewing and listening situation (as one example, a case in which a new fellow passenger gets inside).

For example, in a case in which the implementation of the re-scheduling according to an arbitrary trigger is determined in the middle of the playing of a content based on a created program table, it is not desirable to change the current program composition once approved by the user to a large extent, but it is desirable to carry out the re-scheduling of a program table similar to the current program composition.

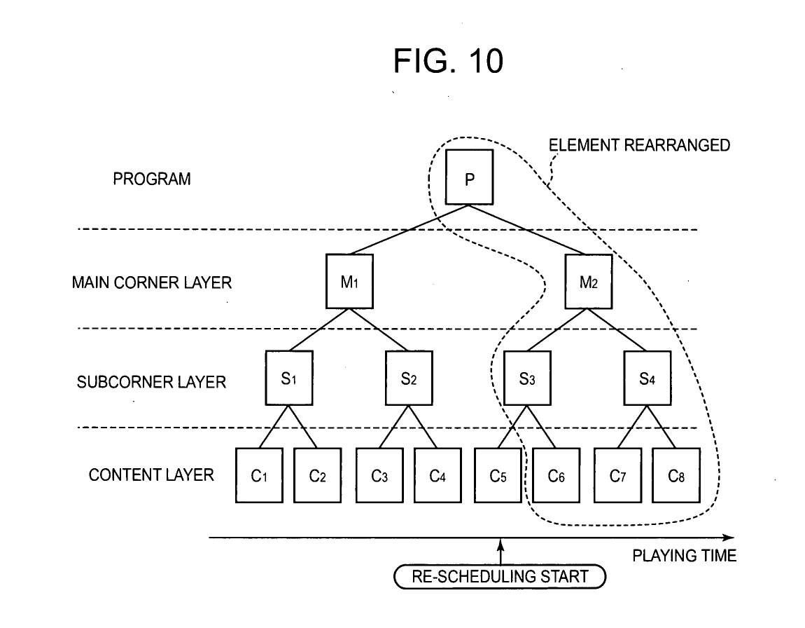

Referring to FIG. 10, a description will be given of one example of a start timing of the re-scheduling of a program table. FIG. 10 is an illustration of one example of a start timing of the re-scheduling of a program table according to an embodiment of the present invention. In FIG. 10, as well as FIGS. 7A to 7D, a program table is expressed by a tree structure.

FIG. 10 shows a program P composed of main corners M1 and M2, subcorners S1 to S4 and contents C1 to C8. Let it be assumed that some trigger for the program re-scheduling occurs in the middle of the playing of the content C5. In this case, the composition after the content C5 played at the occurrence of the trigger is changed. That is, in the tree structure shown in FIG. 10, the elements and the tree structure, related to the main corner M1, the subcorners S1, S2 and the contents C1 to C5, are not changed, but a change is made on a region surrounded by a dotted line, including the program P, the main corner M2, the subcorners S3, S4 and the contents C6 to C8. In the change related to the re-scheduling of the program table, a change is made with respect to the four variables of index, time width, start time and end time in each element, or processing such as addition of an element and deletion of an element is conducted.

For example, when a program table before the re-scheduling or the information produced in process of the creation of the program table are effectively utilized at the re-scheduling of the program table, it is possible to reduce the processing time taken for the re-scheduling of the program table and the processing load thereof. As methods of carrying out such efficient program table re-scheduling, for example, it is possible to use two re-scheduling methods of an initial value utilizing method and a constraint recording method, or a combination of these scheduling methods. Although a description will be given hereinbelow of the initial value utilizing method and the constraint recording method, it is also possible to carry out the program table re-scheduling through the use of other arbitrary re-scheduling methods.

First, a description will be given of the initial value utilizing method for the re-scheduling. This initial value utilizing method is a method of using the current solution (program) as an initial value to impose a constraint condition newly and carry out the re-scheduling for obtaining a new solution. For example, in the case of the example shown in FIG. 10, the variables of the elements related to the main corner M1, the subcorners S1, S2 and the contents C1 to C5 are fixed while, with respect to the variables of the elements related to the program P, the main corner M2, the subcorners S3, S4 and the contents C6 to C8, search processing for a new solution is conducted with the current setting being set as the initial value. This enables a new program table similar to the current program table composition to be re-made at a high speed at the program table re-scheduling.

Secondly, a description will be given of the constraint recording method for the re-scheduling. This constraint recording method is a method of recording information (information such as calculation result in process of the creation of the current program table) produced as needed in process of the acquisition of the current solution (program table) to obtain a new solution through the re-use of this information. As the information available at the re-scheduling, for example, there are a set of candidates for a solution with respect to a combination of constraint conditions, the histories of various constraint solution processing, and others. For example, in the case of the example shown in FIG. 10, search processing is conducted by fixing the variables of the elements related to the main corner M1, the subcorners S1, S2 and the contents C1 to C5 and once clearing out the variables of the elements related to the program P, the main corner M2, the subcorners S3, S4 and the contents C6 to C8 and re-using, for example, the information on a value in a range that the respective variable can take or other non-changed constraint conditions (for example, a condition that news is once in the program, and others). This enables reusing a set of candidates for a solution with respect to a non-changed constraint condition at the program table re-scheduling and remaking a new program table similar to the current program table composition at a high speed.

As described above in the foregoing embodiment, according to the present invention, an automatic creation of a detailed program table for the playing of contents becomes possible through the use of a constraint solution technique (constraint satisfaction technique). Moreover, in particular, a constraint logical programming technique included in the constraint solution technique is usable as the constraint solution technique.

A program table creation algorithm using the constraint solution technique according to the present invention is usable in every program table (multimedia program table) creation situation. That is, it is usable even in a case in which a user who tries to play a content creates a program table for the playing of this content and is also usable even in the case of creating a program on a programming side which performs the production and delivery of a radio program or television program. In addition, in the program table creation according to the present invention, one feature is the automatic creation of a program table and, for example, it is useful to utilize it in a vehicle mounted apparatus for improving the safety of driving by reducing the operations by the user. Still additionally, as mentioned above, in particular, when the program creation processing (particularly, constraint solution processing) where there is a possibility of increasing the processing load is conducted by a specified program table creation server (for example, in a center or server of a service provider or the like), that is, for example, when a constraint condition is transmitted from a user side communication apparatus to a program creation server and a program table created on the basis of this constraint condition is sent from the program creation server to the user side communication apparatus, the user side can acquire an optimal program table.

### INDUSTRIAL APPLICABILITY

A program table creation method, program table creation device and program table creation system according to the present invention provides an advantageous effect that a detailed program table for the playing of contents can automatically be created according to various conditions through the use of a constraint solution technique (constraint satisfaction technique) and are applicable to a technique for creating a program table for the playing of contents.

1. A program table creation method of creating a program table defining a temporal arrangement of a plurality of contents,
characterized in that said program table is created through the use of a constraint solution technique on the basis of a constraint condition related to a selection of said plurality of contents and/or a constraint condition related to a temporal arrangement of said plurality of contents.

2. The program table creation method according to claim 1, characterized in that a description of said constraint condition is made through the use of a constraint condition description function defined in advance.

3. The program table creation method according to claim 1, characterized in that user's liking information indicative of a liking of a user who watches or hears said contents is acquired as said constraint condition.

4. The program table creation method according to claim 1, characterized in that said constraint condition is automatically acquired by automatically generating said user's liking information through learning of said user's liking.

5. The program table creation method according to claim 1, characterized in that state information indicative of a state related to playing of said contents is acquired as said constraint condition.

6. The program table creation method according to claim 1, characterized in that said program table is created by making reference to content attribute information indicative of an attribute of each of the plurality of contents.

7. The program table creation method according to claim 1, characterized in that, when constraint falls into an excess state in constraint solution processing at the creation of said program table, priorities are set with respect to said contents and/or said constraint condition so that said constraint solution processing is conducted while preferentially employing said constraint condition higher in priority.

8. The program table creation method according to claim 1, characterized in that, when constraint falls into a shortage state in constraint solution processing at the creation of said program table, scores are set with respect to said contents and/or said constraint condition so that said constraint solution processing is conducted by making a comparison between a plurality of operation results of operations using a function in which said score is set as a parameter.

9. The program table creation method according to claim 1, characterized in that a constraint logical programming technique is used as said constraint solution technique.

10. The program table creation method according to claim 1, characterized in that said program table is expressed by a tree structure having one or a plurality of hierarchies in which elements indicative of said contents constituting said program table are disposed in a lowest-rank layer and elements summarizing features of lower-rank elements are disposed in a rank higher with respect to the elements indicative of said contents.

11. The program table creation method according to claim 10, characterized in that said elements associated with each other in higher-rank and lower-rank layers have attribute information or time width information consistent with each other.

12. The program table creation method according to claim 10, characterized in that a portion of said program table is rearranged on the basis of said tree structure.

13. The program table creation method according to claim 12, characterized in that the rearrangement of the portion of said program table is made by employing one of a method of deriving a new solution through the use of a previous solution or a method of deriving a new solution through the use of a history related to a previous solution derivation, or by employing a combination of these methods.

14. The program table creation method according to claim 1, characterized in that an arrangement of said contents is optimized on the basis of one of a score set with respect to said contents, a correlation of attributes of said contents and a correlation of said contents or a combination thereof at the creation of said program table or after the creation thereof.

15. The program table creation method according to claim 1, characterized in that said content to be disposed at the next position is determined on the basis of said content disposed at the last position with respect to a time axis.

16. The program table creation method according to claim 1 or 15, characterized in that said content to be disposed at the last position is determined on the basis of said content disposed at the next position with respect to a time axis.

17. The program table creation method according to claim 1, characterized in that an arrangement of said contents is determined on the basis of a pattern of said plurality of contents with respect to a time axis.

18. The program table creation method according to claim 1, characterized in that an arrangement of said contents is changed by making reference to content attribute information indicative of attributes of said contents so that a correlation between said contents adjacent to each other reaches a maximum as a whole.

19. A program table creation device for creating a program table defining a temporal arrangement of a plurality of contents, characterized in that said program table is created through the use of a constraint solution technique on the basis of a constraint condition related to a selection of said plurality of contents and/or a constraint condition related to a temporal arrangement of said plurality of contents.

20. The program table creation device according to claim 19, characterized in that said program table creation device is mounted in a vehicle and made to create said program table of programs to be watched and heard in the interior of said vehicle.

21. The program table creation device according to claim 19, characterized in that a constraint logical programming technique is used as said constraint solution technique.

22. A program table creation system for creating a program table defining a temporal arrangement of a plurality of contents, characterized by comprising:
a program table creation server existing in said predetermined network and so arranged that said program table is created through the use of a constraint solution technique on the basis of a constraint condition related to a selection of said plurality of contents and/or a constraint condition related to a temporal arrangement of said plurality of contents;
a communication unit connectable with said predetermined network and capable of transmitting said constraint condition through said predetermined network to said program table creation server and receiving said program table created by said program table creation server.

23. The program table creation system according to claim 22, characterized in that said communication unit is mounted in a vehicle and said program table creation server creates said program table of programs to be watched and heard in the interior of said vehicle.

24. The program table creation system according to claim 22, characterized in that a constraint logical programming technique is used as said constraint solution technique.
